(19) United States
(12) Patent Application Publication
(10) Pub. No.: US 2014/0300273 A1
(43) Pub. Date: Oct. 9, 2014

(54) LIGHT-EMITTING CONTAINER

(71) Applicant: La Luz Company LLC, Ann Arbor, MI (US)

(72) Inventors: Jeffrey R. LeBrun, Ann Arbor, MI (US); Stephen G. Toner, Provo, UT (US)

(21) Appl. No.: 14/352,842

(22) PCT Filed: Oct. 19, 2012
(86) PCT No.: PCT/US2012/061004

§ 371 Date: Apr. 18, 2014

Related U.S. Application Data
(60) Provisional application No. 61/693,631, filed on Aug. 27, 2012.
(60) Provisional application No. 61/549,164, filed on Oct. 19, 2011.

(51) Int. Cl. F21V 33/00; A47G 19/22

(52) U.S. Cl. CPC F21V 33/0036; A47G 19/2205
USPC 315/76; 362/101

(57) ABSTRACT

A light-emitting container (2) such as a bottle includes a hollow vessel (4) and a light-emitting device (6). The vessel (4) has an open end (8) and a closed end (10). At least a portion of the vessel (4) is one of transparent and translucent. The light-emitting device (6) is disposed adjacent the closed end (10) of the vessel (4). The light-emitting device (6) includes a microcontroller (14) in electrical communication with at least one light source (16). The microcontroller (14) selectively causes one of an activation and a deactivation of the at least one light source (16). A light emitted from the at least one light source (16) is transmitted through the vessel (4) upon the activation of the at least one light source (16).

### CROSS-REFERENCE TO RELATED APPLICATIONS

This application claims the benefit of U.S. Provisional Application No. 61/549,164, filed on Oct. 19, 2011, and U.S. Provisional Application No. 61/693,631, filed on Aug. 27, 2012. The entire disclosures of the above applications are hereby incorporated herein by reference.

### FIELD OF THE INVENTION

The present disclosure relates to a light emitting container and, more particularly, to a tilt-activated light emitting bottle with a timer, in that the bottle can be lit periodically while sitting on a shelf to create an eye-catching display, or it can be tilted to emit an even more brilliant light while it is pouring the liquid.

### BACKGROUND OF THE INVENTION

There are many types of beverages, both alcoholic and non-alcoholic that are available on the market. To differentiate the various brands and types of beverages that the consumer has an opportunity to sample or purchase, distinctive shapes, labels and colors are used on or in association with the beverage bottles.

Several bottles have been designed such that light that is provided from a source external is manipulated or refracted in order to create a pleasurable viewing experience, or to attract the eye. For example, beverages have been concocted that glow in the dark, jewels or crystals have been included in or on bottles, and gold flakes have been infused into the beverage mixture. Bars are often designed such that external lighting sources direct light onto the bottles, but this generally does not have the advantage of providing more or less light to a specific brand.

Others have attached lights to bottles, but these designs typically suffer from greater power consumption or unbalanced power management. Also, some bottle fights have been powered from a stationary, plug-in power source instead of from a battery supply. These products are not considered to offer the same benefits of product mobility, or practicality in a commercial setting. Most bottles containing lights typically have a simple on/off switch, reed hermetic switch, or other switch such that the user must manually select whether they want the bottle to be “on” or “off”, rather than having the bottle react to their actions. No known examples of the prior art have successfully incorporated sensor-activated LED lights with a microcontroller-based design that can be manufactured using surface mount technology.

There is a continuing need for a container that is both visually appealing and affordable. Desirably, the container is light-emitting and when handled will reward the consumer with a pleasurable experience.

### SUMMARY OF THE INVENTION

In concordance with the instant disclosure, a container that is both visually appealing affordable, and which is light-emitting so that it rewards the consumer with a pleasurable experience when handled, is surprisingly discovered.

To provide another manner of providing a pleasing or distinctive appearance of such bottles, the current invention provides a way to light such bottles safely and inexpensively to give the appearance as if such light sources are inside the bottle. In most cases, this bottle will emit some light from the internal structure when it is stationary. When the bottle is picked up, moved, or poured, it will sense this motion and will emit more light. The sensation of light coming out of the bottle when it is handled will reward the consumer with a more pleasurable experience when the bottle is being used, then when it is allowed to sit still.

There are no existing commercial applications of a tilt-activated light-emitting bottle. Prior art attempting to integrate lights into packaging for the beverage industry has the several disadvantages. Many of these disadvantages are related to the inability to create adequate power management required to create a light-emitting device with the appropriate design to make the light appear brilliant and bright while being long-lasting with sufficient battery lift and compactness enough to fit inside a bottle package. Batteries used are often too large or of too limited a voltage and capacity. For example, alkaline batteries are 1.6V and most do not fit within a reasonable space. Although circuit boards have been designed that include LEDs, there are no circuit boards currently used in combination with sensors in the beverage industry. This requires space and limits the power life of the device. Analog designs have been attempted, but these designs have increased assembly costs, are unreliable and often have parasitic power losses that drain the battery life. Although examples of microcontroller bottle lights are not known, it is an additional requirement to specific a microcontroller combination that is sufficiently low power and affordable. Finally, even with the appropriate assemblage of components, the electronics design may not be designed appropriately. The results of previous inadequate designs have been attempts at electronic packaging for the beverage industry that are not affordable, not sufficiently compact enough to be contained in a visually appealing package, not reliable enough, not programmable, not activated by sensors and not able to be manufactured robotically.

A primary object of the disclosure is to provide a tilt-activated light-emitting bottle. This bottle also contains a timer, such that the bottle may light for 30 seconds once every 30-40 minutes without running out of battery life for at least 6 months. The purpose of this timer feature is to provide an eye-catching display while the bottle is sitting on a bar or a shelf, without running out of battery life during the expected lifetime of the product. This disclosure also contains a tilt sensor, such that the bottle will light up while it is inverted, so that the bottle is lit with extraordinary brilliance when the bottle is poured. This feature is expected to provide the pourer or recipient of the pour a unique experience and potentially to draw attention from others who are present for this event.

This disclosure utilizes a carefully selected combination of components that result in a low-power system, which is able to achieve a bright lighting effect with only 1-2 primary battery cells. A unique low-power microcontroller is used, which is programmed as part of the component manufacturing and assembly process. This circuit and combination of components are unique.

Methods of Operation:

The light-emitting device of the disclosure may be operated to illuminate a beverage containing vessel. Additionally, a motion sensor can be used to trigger the illumination. More specifically, the light-emitting device of the disclosure will illuminate a beverage containing vessel for a period of 30 seconds after being poured. The purpose of this feature is to provide enjoyment to the customer, and to reward them for purchasing the beverage.

Additionally, the light-emitting device can be pre-programmed such that a second LED light illuminates periodically. By default, this will occur once every 20-30 minutes. The purpose of this feature is to catch the attention of a potential customer when the product is on the shelf at a store or in a bar.

The battery life in this design is sufficient to enable the amber colored light to activate for 30 seconds once every 30 minutes for a period of 6 months, while also having enough power to fully power the blue LED at least 50 times.

The device must be powered in “on” mode in order to operate. This is controlled by a basic on-off switch.

The light-emitting bottle of the disclosure utilizes a carefully selected combination of components that result in a low-power system that is able to achieve a bright lighting effect with only one or two primary battery cells. A unique low-power microcontroller is used that is programmed as part of the component manufacturing and assembly process. This circuit and combination of components are unique.

The low-power light source is constantly on when the “on/off” switch is turned to “on”. The low power light source can be a steady, constant power LED or a flickering LED. A timer may be attached such that the low power source comes on periodically. For example, the lower power source may come on one minute out of every five minutes. The effect of this timer may be to grab the attention of somebody who is shopping or who is sitting at the bar. The timer may have an adjustable feature such that the user may determine the timing and behavior of the low-power source.

Battery Selection and Power Management:

Batteries are rated by their amperage and voltage and energy capacity. Energy density, measured in watt hours per liter is important in order to ensure that the battery can store sufficient energy inside a given space. There are tradeoffs between the various battery formats and reaction chemistries. Some batteries, such as lithium batteries, also generate increased internal resistance over their lifetime. Other batteries meet the necessary technical requirements but may be too expensive for a light-emitting device that is related to packaging or enhancing the appearance of another packaging or glassware product.

Although batteries have a stated output voltage, they do not produce exactly this voltage for their entire life. Typical discharge curves show the voltage produced by a given battery cell over time. The shape of the discharge curve varies based on the battery chemistry as well as the discharge rate. It is known that lithium cells do have a fairly flat discharge curve with a rapid falloff at end of life, but only briefly produce 3V or higher.

Power source selection is important because the design of the circuit requires an optimized operating voltage range in order to maintain sufficient battery life. If the circuit operates outside of the voltage range, there will either be additional inefficiencies that result in parasitic power loss or the light will not be sufficiently bright. LEDs have a minimum voltage that is required for the LED to produce sufficient light to illuminate the bottle and to make it visually appealing. It is known that different designs and colors of LEDs have different voltage requirements. Within the constraints of device size, reasonable costs and light intensity, and operating life—the balancing of circuit design, battery selection, and LED selection is a complicated power management problem.

A resistor in series with an LED will give a fairly constant current throughout the battery life if this type of battery is used (but see note below on internal resistance). The discharge curve of Alkaline battery cells has a much more drastic falloff.

In contrast to the 3V lithium coin cell design, a 9V battery's output would range from 9+V to about 5.5V across its useful life. To the ordinary electronics designer, the ability to access additional voltage to light up one or more LEDs would appear to be desirable, with higher voltage seeming to assure additional potential for illumination. However, although 9V batteries are frequently used, controlling the current delivered to an LED with this kind of variance in voltage is more intensive than for the lithium batteries flat curve and could require additional hardware. Another factor with the 9V battery is that the PIC 10F200 cannot run on 9V—it is only specified to operate in the range of 2V-5.5V. Both of these issues by passing the battery are output through a voltage regulator. However, that approach would increase parts count and cost, and the regulator would consume some battery power. A 78L05 regulator, for example, requires 3-5 mA quiescent current, which exceeds our budget. The TPS77050 regulator commercially available from Texas Instruments Incorporated is suitable, however, as it can provide up to 50 mA (more than we need to power the microcontroller and LED), and only draws 17 μA of quiescent current [TPS77050].

The effective capacity of a battery does not always match its rated capacity. In the case of lithium coin cells, such as the CR2032 rated at 220 mAh, the internal resistance of the battery increases rather dramatically as the cell is used. See Texas Instruments White Paper SWRA349 by Mathias Jensen, published Aug. 30, 2012 (available online at http://www.ti.com/lit/wp/swra349/swra349.pdf). This causes an output voltage drop that depends on the current being drawn, making the battery appear to be “dead” even though it still has capacity to deliver smaller amounts of current within the rated output voltage range.

Note that at about 75% of the rated capacity, the internal resistance for a CR2032 cell across its life exceeds loom. In our circuit, we have a microcontroller that requires very little current, and an LED that requires quite a bit more. This resistance increase will cause an LED driven by the coin cell to dim over time, even though the battery is still capable of powering the microcontroller.

If a primary power source could be lithium or alkaline, but lithium is preferred due to the higher voltage potential. Silver oxide batteries or vanadium oxide batteries can also be used. A small solar panel maybe integrated with a rechargeable lithium-ion battery into the label or other part of the bottle in order to recharge the bottle. The preferred embodiment is one or more primary lithium cells, due to the combination voltage potential, affordable cost, recyclability and energy density. Rechargeable battery cells could be used. These could either be AA or AAA sized, or larger size. A custom designed lithium-ion pouch cell may also be used if higher energy density is required in a rechargeable format and if cost is less of an issue. Multiple battery cells may be wired in series in order to increase the voltage. In our prototype, we used two primary lithium coin cells (3V) to power two LED lights.

In another embodiment, an energy harvesting device or a solar panel, or solar paint, could be integrated into the described power management system with a rechargeable battery. This would increase the time between battery changes, potentially enabling brighter LED operation without negatively affecting the convenience of the user, albeit at a higher cost. If a solar energy generation source was utilized, several types of panels are available. A thin film solar panel that is flexible in nature, such as the amorphous silicon panel manufactured by United Solar Ovonics, could provide a more aesthetically pleasing design.

In another embodiment, an additional input could be provided to the user to reduce or elevate the current delivered to the LED. This device could enable the end user to set the device to work either in “bright light mode” or “power saving mode”, depending upon their preference. The key difference in this embodiment is that the user could decide after the point in time where the device was manufactured and programmed at the factory.

Analog Design Considerations:

Analog electronics designs become commercially available long before microcontroller-based designs. The low cost and familiarity of analog electronic designs has enabled them to remain as the de facto design platform for a wide range of inexpensive consumer products. Accordingly, an analog design may be employed. A digital design is described in disclosure due to certain benefits that were realized after performing several complex power management calculations, performing cost estimates and building prototypes using each design method. Analog designs can be used to create timers and to trigger the activation of an LED using a tilt sensor or motion sensor input.

An example of an analog design that could achieve this is called an (asymmetric) astable multivibrator, and consists of 4 resistors, 2 capacitors and 2 transistors. However, if a timer is desired capable of discharging power through the light circuit with several minutes between discharges, additional large resistors and capacitors must be used. If these are not used, then the light will discharge too frequently and the battery will be drained within days of sitting on the shelf, rather than over months. Field effect transistors (FETs) with high gate threshold voltage can be used for the transistors instead of bipolar transistors. FETs are also available in dual configuration (2 to a package), which reduces the parts count and therefore assembly cost. The higher gate threshold FET will reduce the capacitor values, but they will still be large. Large capacitor values mean large size and/or poor tolerance (typically ±20%). Increased tolerance of up to 10% can be had with tantalum capacitors, but they are more expensive as a rule than electrolytic capacitors.

In the analog design, one design consideration for reducing component count is a timer chip, such as the ubiquitous NE555, running as an astable multivibrator. One time constant controls the 15-20 minute delay while the other controls the 30 second LED on time. Two resistors and one capacitor are used to set the time constants. However, the 555 is unusable in this application because it has a quiescent current of 3-10 mA (typical, depending on supply voltage) [for example, NE555 commercially available from Texas Instruments Incorporated], which far exceeds the 45 μA budget. There are CMOS versions of the 555 timer chip which draw less current (for example, LMC555 and TLC555 commercially available from Texas Instruments Incorporated]). However, they still require 100 μA [for example, LMC555 commercially available from Texas Instruments Incorporated]. Large capacitor values are still required.

One unique feature of this disclosure is the inclusion of a low-cost, low-power microcontroller.

Microcontroller-Based Design for Sensor-Activated Beverage Light:

This disclosure is for a microcontroller-based design for achieving the desired goal of illuminating a beverage-containing vessel brilliantly upon input from a sensor, with a cost-of-goods sold of less than $3-$4. Additionally, this design enables additional features that include an additional timer, inclusion of a second-colored LED light, and integration with an entirely robotic manufacturing process for the electronic component of the disclosure. This disclosure is also sufficiently compact to fit within the casing of a bottle, such as a 750 mL bottle containing alcoholic spirits.

An embodiment of this design is described here: The PIC 10F200 commercially available from Microchip Technology, Inc is a low-cost ($0.30 in qty: 5000 direct from Microchip), low-power microcontroller with built-in timing circuitry. It operates on voltages from 2-5.5V, and is designed for use in battery-powered equipment. In SLEEP mode with the watchdog timer enabled (providing timing capabilities and exit from SLEEP mode), typical current draw is on the order of 2.5 μA (3V power supply) to 7 μA (5V power supply) [PIC 10F200]. Typical current draw when operating is 300 μA (3V power supply) to 700 μA (5V power supply), but the processor would only spend very brief periods in this mode—just enough to update internal variables and adjust outputs before going back into SLEEP mode.

When compared to an analog design, a microcontroller design can also reduce the parts count needed to achieve a similar level of functionality. Since the microcontroller has internal timing circuitry, no external timing capacitors are necessary. A minimal design would require the PIC10F200, a tilt switch, 2 LEDs and 2 resistors, plus the battery and its associated clip. The total parts cost using the latest cost estimates (not including battery) would be about one dollar.

The downside of using a microcontroller is that it must be programmed. Programming the microcontroller requires that the designer to have additional software skills in addition to electrical engineering hardware skills. Selecting the appropriate microcontroller-based design to meet all of the design requirements for a commercially successful product requires an in depth knowledge of circuit design and optimization, microcontroller software development, power management and manufacturing costs for electronic parts. This rare combination of abilities is the reason why no company in the multi-billion dollar spirits industry has yet conceived or launched a large-scale commercially successful beverage illumination packaging technology using a microcontroller-based design. Additionally, costs of the components used were much higher even only a few years ago. The costs are still only marginally economical in today's environment, although steadily declining electronics components costs should make this design affordable for the mass market.

This bottle list also contains a timer, such that the bottle may light for 30 seconds once every 30-40 minutes without running out of battery life for at least 6 months. The purpose of this timer feature is to provide an eye-catching display while the bottle is sitting on a bar or a shelf, without running out of battery life during the expected lifetime of the product.

LED Selection:

Although most LEDs are designed for 10 mA, they (or at least most) will operate with reduced light output at 2 mA. There are some LEDs that are specifically sold as “low current LEDs” and specified at 2 mA. In general, the operating voltage depends on the color of the LED. The below TABLE shows typical forward voltages for different colors.

TABLE
Required voltages for LED of various colors.

| LED Color | Required Voltage |
|---|---|
| Amber | 2.4 V |
| Blue | 3.2 V |
| Green | 2.2 V |
| Orange | 2.1 V |
| Red | 2.1 V |
| White | 3.2 V |
| Yellow | 2.2 V |

Note that blue LEDs, as specified in the requirements, require more than 3V. Also, as noted above, a 3V battery does not actually produce 3V for most of its life. There is not actually 3V to use if the LED is connected between the battery positive (+) and the microcontroller's output pin. The microcontroller can only pull the output down to about 0.6V. It is possible to eliminate this 0.6V drop (e.g., by using a high-side switch based on a P-channel MOSFET), but this adds parts and increases cost, but that still doesn't get us to the level we need to drive the blue LED. Additional circuitry to generate a higher voltage from the 3V battery would increase parts count and cost and battery drain as well. Therefore, without a novel combination of microcontroller and other power management electronics, using most blue LEDs would almost certainly require use of a 9V battery.

It is known that the relative intensity of the LED is affected by the forward current that is delivered to the device. Although more current results in greater light intensity, it will also drain the battery faster. The circuit design and the programming therefore must manage the inherent tradeoff between light intensity and battery life. Inadequate power management and programming could result in hours or days of battery life rather than weeks or months. Without working diligently to achieve an optimized microcontroller design, fabricating prototypes, and examining the brilliance of the light, a person who is skilled in the art would be likely to assume that adequate light intensity and battery life are not achievable at the same time given the constraints of a device that fits underneath a bottle and that costs less than a few dollars to make.

This challenge is important because a blue LED is considered to be part of one preferred embodiment. Blue is considered to be a preferred embodiment because this disclosure is considered to be particularly relevant to marketing of premium and ultra premium spirits products like vodkas, tequilas, and aperitifs. Blue is commonly associated with ice, which is associated with vodka. Blue agave is commonly associated with tequila. Therefore, blue has a particular marketing relevance. Additionally, it has now been observed that the combination of a blue LED with frosted white glass, or blue tinted glass is particularly visually appealing.

Matching Glass with Light Source:

The wavelength of the light emitted by the LED affects the color that is perceived by a person who is viewing the product, such as a consumer, potential customer, or aspiring customer. This wavelength, and color, depends on the band gap energy of the materials forming the p-n junction within the light. Different materials are generally required to produce different types of LEDs. Therefore, colors of LEDs are limited in selection and costs of certain colored LEDs can be very different. Blue LEDs typically have a wavelength between 450 and 500 Angstroms, with a voltage drop between 3.7 and 2.48. Blue LED semiconductor materials are typically comprised either of zinc selenide, indium gallium nitride, silicon carbide or silicon. Of these, Silicon is considered to still be under commercial development.

An ultraviolet LED is considered to be another preferred embodiment. An ultraviolet light has potential to be used in combination with black light paint and other materials that are designed to be illuminated by a black light. This could have interesting marketing effect. Additionally, materials that are illuminated more by black lights could be infused into the glass or into the beverage itself to provide an additional visual effect. For example, a beverage that appears to be clear in normal light could be illuminated by the black light periodically or when the beverage is poured. Although there are several embodiments for how this might be achieved, one embodiment is to combine the tilt-activated UV light with a beverage that is infused with a vitamin that happens to reflect UV light, such as vitamin B12. Tonic water also glows when exposed to a black light. Some types of food coloring may also glow when exposed to a black light, as do vitamins B1, B2, B3, and chlorophyll. Algae that contain chlorophyll or other UV reflecting compounds may also be included as a micro-ingredient. Many of the vitamins that glow when exposed to UV are also contained in energy drinks, and a UV-tilt activated light may be used to build brand association between the color of the beverage and the energy-drink like properties. Mixed drinks containing tonic water that are in proximity to the bottle would also glow. Some types of vodka, absinthe, tequila and blue curacao may also exhibit glowing properties, depending upon the recipe and production process. Although prior beverages such as Hypnotiq™ have been developed that are intended to glow when exposed to UV light. The combination of these specific beverages with a UV LED is considered to be part of this disclosure, regardless of the presence of a microcontroller or the presence of a tilt sensor or other motion sensor.

In another preferred embodiment, the wavelength of light that is emitted by the micro-controlled-LED could be very near the wavelength of light that is reflected by the glass vessel. For example, a blue light could be combined with a blue-tinted glass. After testing, it has been observed that this combination results in a particularly attractive and brilliant illumination.

Discuss Specific LED Selection:

The LED's selected for the preferred embodiment were designed to be surface mounted. The design that was reduced to practice include d two LEDs. One LED was connected to the timer circuit that was controlled by the microcontroller. A second LED was connected to the microcontroller, and was activated by the tilt sensor. In one example, the LED that is connected to the timer could be amber. The second LED could be blue, and the glass could be tinted blue. This sequence could give the effect of “fire putting out water”. Other sequences could be more appropriate for special varieties of a brand—such as the colors of a sports team or colors associated with a holiday (ex: green and red LEDs sequenced for a special Christmas edition of a spirits brand).

Software:

Software is used both in the design process as well as in operation of the device. During manufacture of the device, electronic instructions are sent that instruct the pattern in which the substrate will be etched to be conductive. The positioning of each electronic component must therefore be fully specified and selected prior to making the device. This software instructs a robotic, surface mountable assembly line in the creation of physical design of the circuits as well as the placement of the electronic components onto the substrate after the circuits are etched.

Software instructions must also be sent to the microcontroller. These instructions are programmed into the microcontroller at the time the device is manufactured. The software instructions programmed into the microcontroller direct the timing function as well as the sensor inputs that trigger the powering of the LED. For example, the prototype that was manufactured used software to instruct an amber colored light to operate for 30 seconds once every 30 minutes. The software also instructed the microcontroller to direct even more current to a blue LED when it received input from a tilt sensor that indicated that the device was being tilted more than 15 degrees from being perpendicular to the gravitational field. The software enabled this device to be used this way for up to 6 months with two 3V CR2032 primary lithium cells before the lithium cells would be discharged such that the brightness from the blue LED would no longer be sufficient to be visually appealing. Alterations to the software could be used to optimize for greater illumination or great battery management, depending upon the desires of the customer or end user.

Glass Design and Electronics-Packaging Interface:

Aspects of bottle and beverage design may be combined with certain wavelengths of LED light sources to produce more desirable effects. For example, the combination of a green light with a green bottle produces a more desirable effect then the combination of a blue light with a red bottle. A blue light with blue bottle also produces a desirable effect.

The glass could also be designed for maximum refractive brilliance. The top could be cut in a way that it is faceted, like a gem, to help refract the light coming from the bottom of the bottle. Alternatively, gems or crystals may be cut to add additional refracting to the light that is emitted from the glass.

Alternatively, the bottom of the bottle could be shaped like a gem, a stone, or piled ice cubes. The effect would make it look like a brilliant jewel was in the bottom of the bottle and that it was coming alive when they consumed the beverage.

A glass “lens” that is the bottom of the bottle could also help to redirect the light from the LED, to where it is most effectively scattered by the top of the bottle.

The outside of the bottle may be blended to include lead oxide glass, which has a higher refractive index than standard silicon glass. Because lead is toxic in higher quantities, in order to prevent lead from leaching into the glass, the two glass types would be blended such that the lead oxide glass does not come into contact with the beverage. The lead oxide glass that is present on the external portion of the bottle could then be cut to form structures with sharp edges that add additional brilliance to the glass by creating sharper and more diverse refracting patterns. An alternative way to prevent lead oxide from leaching into the beverage would be to coat the lead oxide glass with a thin film of another transparent material that would block the lead from leaching. This could potentially be achieved through one of many thin film deposition techniques, such as sputtering or electron beam. The coating material could be evaporated in a vacuum atmosphere and deposited as a thin layer over the lead oxide glass. Suitable materials would be transparent, stable, able to block lead from leaching through it, and would preferably have fast deposition rates.

The outside of the bottle may be coated with another substance that affects the way the light is displayed. For example, a frosted coating could be applied. Additionally, a coating could be applied to the bottle that may alter or disperse the wavelength of the light on the external surface of the glass after it is emitted through the bottle but prior to being viewed. Similar coatings are already used to affect the perceived light quality of white LEDS and are commercially available. A glow-in-the-dark style coating could also be used. A coating that fluoresced or appeared to be very active with a black light could be used in combination with a UV light in order to achieve a very noticeable effect when the light was activated by the sensor.

Etched Substrate Design and Method of Manufacture:

The design of this electronics device is also unique in that the components are designed to be manufactured using automated, surface mount technology (SMT). SMT is a method for constructing electronic circuits in which the components are mounted directly onto the surface of substrate that is designed and etched to be electronically conductive between selected electronic components. In contrast, many other low-cost electronic devices have been made using through-hole technology or by manually soldering them. These approaches require less skilled design and are more amenable to building prototypes manually or with breadboards rather than by soldering directly. Manual soldering of SMT components can easily destroy the components, which are also so tiny they require tweezers or other additional equipment to place. Although through-hold technology is considered to be easier to design products for manufacture with and is still commonly used for many low-cost LED products, the through-hole or manual assembly methods require more labor and is generally are not as robust to withstanding the bumps and jolts of an electronic packaging application. It would be difficult to make a tilt-activated LED device commercially for the beverage packaging industry using either of these manufacturing platforms while meeting all of the cost, battery life, and quality requirements required by the customers.

In a preferred embodiment that we reduced to practice in our functional prototype, a single-sided etched substrate is used as the base. Although multi-sided or multi-layered substrates are available, the design of the circuits was compacted in order to allow the entire device to fit onto a single-sided etched substrate. Single-sided etched substrates are relatively inexpensive to make, with a high degree of reliability. Additionally, the side that does not contain the circuit may be glued directly to a base material that may be integrated with the remainder of the beverage package. This method of manufacture enables a rapid assembly of the electronics into the remainder of the beverage packaging that will not be prone to defects.

Although the etched substrate used in the prototype that we fabricated is circular, any shape of etched substrate may be used as the base. A circular etched substrate design may be preferred in some embodiments because it offers the maximum available space while being able to be contained entirely within the footprint of a circular bottle. Additionally, a circular etched substrate design may offer additional mechanical support or more facile integration with the bottle or base of the packaging design.

The components selected in the design of this disclosure are manufactured in a way that they are available in large quantities on reels. This distinction requires the ability of one to make designs using software on a computer, because breadboard prototyping is not possible, placing this type of design out of reach of most electrical engineers. Because all of the components used in this design come on reels that are intended to be used with an SMT assembly method, they can be manufactured cost efficiently—but only in large quantities. Although there is some prior art related to illuminated glass, the vast majority of these designs are not designed using components that also enable manufacturing using an SMT method.

Sensors:

This disclosure also contains a tilt sensor, such that the bottle will light up while it is inverted, such that the bottle is lit with extraordinary brilliance when the bottle is poured. This feature is expected to provide the pourer or recipient of the pour a unique experience and potentially to draw attention from others who are present for this event.

A similar effect could also be achieved by having a small, enclosed liquid container, even in the base of the bottle. The viscosity and conductivity of the liquid could be tweaked to achieve the desired effect. For example, a very thick, viscous liquid could be used if it was more pleasing to have some delaying during the pour. Many switches used to be fabricated this way that contain mercury, but another conductive liquid material is preferable due to the toxicity of mercury.

A rolling-ball tilt switch may also be used to turn on the high-power LED light or LED array. A conductive ball that is housed in a tube is angled such that the ball rolls to complete the circuit when the bottle is not upright. Any angle can be designated although the sensitivity may preferably be angled at 45 degrees.

A pressure switch may also be used to turn on the high-power LED light or LED array. In this mechanism, the weight of the bottle compresses a mechanism that breaks the circuit for the high-power LED light or array. When the bottle is lifted, the high power LED light or array is powered “on” and the bottle is illuminated.

A circuit could also be incorporated that includes a gyroscope or accelerometer. These could be external to the circuit. Alternatively, a circuit board could be designed that contains these devices along with the embedded logic to drive the switch.

One way to create a switch to turn on the brighter lighting elements is to complete the circuit when the liquid is inverted upside down. For example, this can be achieved by connecting the wires near the mouth of the bottle. A tube switch can also be designed such that a liquid completes the circuit and lights the LED.

A light sensor may also be integrated into the device in order to help the power management. The intensity of the light could be adjusted as a function of the light intensity that is detected by this device. The current delivered to the LED could be increased when the light conditions were dark enough for the light to be visible. Conversely, the entire circuit could be set to “off” mode during daylight. Slight alterations to the design and programming could be done to selectively alter the operations of one or more LEDs. For example, the LED running on a timer could be programmed to run only in dark environments. The additional incorporation of a light sensor could be used either to help save battery life or to boost light output in conditions with substantial ambient light, depending upon the goals of the user and the situation.

A touch sensor, such as a touch capacitor may also be integrated with the microcontroller design to trigger activation of one or more LEDs within the bottle light. This would activate the bottle light when a portion of the label was touched. Two or more electrical leads may also be incorporated as a conductive element to the label, with sensitivity of the microcontroller programmed such that the conductivity of a human hand is sufficient to activate the bottle fight.

The low-power light source is constantly on when the “on/off” switch is turned to “on”. The low power light source can be a steady, constant power LED or a flickering LED. A timer may be attached such that the low power source comes on periodically. For example, the lower power source may come on one minute out of every 5 minutes. The effect of this timer may be to grab the attention of somebody who is shopping or who is sitting at the bar. The timer may have an adjustable feature such that the user may determine the timing and behavior of the low-power source.

One way to create a switch to turn on the brighter lighting elements is to complete the circuit when the liquid is inverted upside down. For example, this can be achieved by connecting the wires near the mouth of the bottle. A tube switch can also be designed such that a liquid completes the circuit and lights the LED.

A similar effect could also be achieved by having a small, enclosed liquid container, even in the base of the bottle. The viscosity and conductivity of the liquid could be tweaked to achieve the desired effect. For example, a very thick, viscous liquid could be used if it was more pleasing to have some delaying during the pour. Many switches used to be fabricated this way that contain mercury, but another conductive liquid material is preferable due to the toxicity of mercury.

A rolling-ball tilt switch may also be used to turn on the high-power LED light or LED array. A conductive ball that is housed in a tube is angled such that the ball rolls to complete the circuit when the bottle is not upright. Any angle can be designated although the sensitivity may preferably be angled at 45 degrees.

A pressure switch may also be used to turn on the high-power LED light or LED array. In this mechanism, the weight of the bottle compresses a mechanism that breaks the circuit for the high-power LED light or array. When the bottle is lifted, the high power LED light or array is powered “on” and the bottle is illuminated.

A digital circuit could also be used that has a gyroscope or accelerometer. These could be external to the circuit. Alternatively, a circuit board could be designed that contains these devices along with the embedded logic to drive the switch.

Electronics Packaging Integration and Interface:

The electronic device should be integrated into the beverage vessel design in a way that is robust, easy to assemble, and able to be manufactured cost effectively in large quantities. The interface between the electronics and the packaging may be intended to be permanent, such as with an adhesive, or temporary, such as with a threaded, screw-on design. The threaded interface design may be superior for applications where the battery needs to be changed. Additionally, a threaded interface may enable a single electronic piece to be used in combination with multiple bottles, or for different LED-bases to be used interchangeably with different bottles. With a standardized and removable interface, it would therefore be possible to have multiple colors and designs that are compatible with different versions of LED-microcontroller bases that have different colors, operating profiles, or casing designs.

In one embodiment of the possible vessel-base-interface for enclosing the LED device, the vessel may include a threaded portion that is compatible with another separate piece. In this embodiment, the vessel is preferably comprised of either glass or metal and the base is preferably comprised of either metal or plastic. With a coordinated design, molds could be created to enable a very tight integration of the vessel with the base component. The base component could be designed such that the etched substrate could be snapped or glued into place. The base component could also be designed to enable access to the off-on switch without the need to remove the base component. This could be achieved in several ways. One way to provide access to the on-off switch may be to leave an opening in the base material design so that it is accessible by touch. Another method may be to integrate the base material with a rubber membrane and a button, such that the button clicks out or in when it is off and on mode, respectively, or vice versa. This embodiment would enable quick removal of the base from the beverage vessel.

In another embodiment, the vessel-base-interface may be design such that the base sleeve can slide over it. In this embodiment, the base material may be joined to the glass with an adhesive or snapped into place using friction.

In a less likely embodiment, the micro-controlled LED light maybe incorporated inside of the glass itself. Achieving this design would take extra measures during manufacture, such that the heat of the glass molding process did not destroy the device. One method of achieving this might be to enclose the device in a metallic shell during the manufacture process that protected it from the molten glass. If the metallic shell had sufficient heat transfer properties, a high melting point, and was in fluid contact with another heat sink, such as water, it may not melt. After fabrication of the glass, the metal could be dissolved into a solution, such as a strong acid that did not dissolve either the glass or any of the circuit boards. The metal shield could also potentially be removed in an electrolyte through electrolysis after fabrication of the glass. In another manufacturing method for achieving this embodiment, a portion of the glass bottle could be blown around the LED device.

In another embodiment, the vessel may be designed such that the etched substrate is adhered, screwed, or snapped directly into place without an additional base piece. In this embodiment, there would be only two pieces.

### ADDITIONAL EMBODIMENTS

Although the preferred embodiment described in this application is related to combinations of this disclosure with glass bottles containing beverages, there are other applications. One example is a glass or plastic glass that incorporated a sensor-activated micro-controlled-LED device. These devices could be sold in tandem with the bottle itself, or used in the household to reinforce the strength of the brand. Additionally, because the end customer is more likely to hold a glass longer than the bottle itself, they are likely to derive additional enjoyment from the illumination of their glass.

Other applications may exist, such as perfumes, makeup containers, chemical solvents, and dangerous chemicals. For example, the LED could light up when a jar with a dangerous chemical was picked up. This would provide additional safety precautions for handling of dangerous chemicals in the event of power outages or sudden darkness.

Other combinations may exist where the energy emitted by the micro-controlled device packaging is known to stimulate or activate the chemical inside. For example, most aromatic substances such as perfumes have increased fragrance when they are heated. A sensor in combination with a microcontroller could provide heat, current, or light to enhance the fragrance of these compounds selectively when they are being sampled or used by a person. Increasing activation or evaporation selectively during use with a micro-controlled device such as the one described in this disclosure may increase the effectiveness of the product when it is being used, without wasting its effectiveness or evaporating it when it is not in use. In designs where heat was applied, the capacity of the battery would likely be larger. There would increased usefulness of adding additional power sources in combination with a rechargeable battery.

In an embodiment where the micro-controlled sensor device was used in combination with a perfume bottle, it may also be preferable to utilize a combination that includes inductive charging with a rechargeable battery. In this embodiment, an inductive charging mat is preferably located on or under a counter or shelving unit.

In another embodiment, an inductive charging power source may be used as the sole power source for a translucent packaging device containing an LED or other light source. In this embodiment, because of the more ready access to power, a battery cell may not be required.

In one embodiment, capacitor or thin film rechargeable battery may be desirable. If energy storage capacity of the capacitor could be sufficient to be matched to the desired time then the capacitor could be used as a timer after it was activated by the tilt switch. A microcontroller may not be necessary in this embodiment because the inductive charging of the device would make it convenient to charge the device while it was sitting on the shelf. In this embodiment, the shelf itself may be designed to be an inductive energy source. Because of the proximity of charging, the energy storage of the total device might be little enough to operate the LED's for less than 5 minutes. Many energy storage devices are not suitable for applications where the current from the device is withdrawn at a rate that is faster than 1 C, which is defined as fully discharging the device over one hour. Unlike the teachings of the prior art, these a battery cell would probably not be suitable for a design where the total energy storage. Instead, a capacitor is recommended. If a capacitor is used, the capacitor may be an electrolytic capacitor, tantalum capacitor, ceramic capacitor, thin film capacitor, niobium oxide capacitor, super-capacitor, ultracapacitor or any other capacitor.

For example, a combination of two primary CR2025 cells, commercially available from The Energizer Battery Company, would provide 326 mAh at 6 Volts if they were wired in series. An ultra-bright surface mountable LED commercially available from Harvatek Corporation could be expected to provide luminous intensity above 1000 mcd with a current of 20 mA. Assuming 80%-90% efficiency after parasitic power loss and self-discharging, the combination of this light and two CR2025 cells could be expected to provide between 13 and 15 hours of light, at an average discharge rate less than C/10. This range is perfectly suitable for primary lithium batteries. However, faster discharge rates can lead to unsafe conditions.

However, in an inductively-charged system, less power may be required to operate the light. Discharging lithium cells too quickly can generate heat that can lead to dissolution of safety systems that are built into the cell. This inherent aspect of primary lithium cells would take away the ability to use a small, primary lithium ion cell. These cells contain lithium metal, which combusts when exposed to water. Although the cells would be generally considered to be safe, there will inevitably be defects. It could be considered to be unsafe to discharge lithium cells too rapidly, especially in an environment such as a bar or club environment that is full of (often flammable) liquids and large numbers of people. Even high rate lithium sulfuryl chloride cells designed for military applications have a maximum discharge rate of 10 C, or fully discharging the cell over 6 minutes. Even though these types of cells are impractical for the aforementioned packaging application they still carry more energy than is required for an inductively charged LED packaging application. Unlike the prior teachings of LED lights in bottle applications, a primary lithium cell does not fit into the design of an inductively charged system that is optimized for cost, size, power management and safety.

For example, in order to deliver 1 minute of light to an LED combination with mA of current requirement at 3.2 volts, the capacitor would need to be able to deliver 6 ampere-seconds, or 19.2 Farads.

In another embodiment utilizing an inductive power source for the bottle light, no energy storage device may be required at all. In this embodiment, the light-emitting device contained in the bottle could light either when it is placed onto an inductive charging mat. This design may not require any energy storage source at all, the simplicity of which would help to reduce the cost of the device.

In order not to waste energy generated by the inductive charging source, a system for communication between the packaging apparatus and the inductive charging source may be desired that triggers the inductive charging source to release energy in the form of an electromagnetic field only when a device is in proximity that is capable of converting that energy into electricity. Although there are several ways of achieving this communication, is the method that is described by the Wireless Power Consortium. Staying compliant with this method would ensure that the illuminated beverage devices would be compatible with some of the commercially available inductive charging platforms.

Another method for communication with the inductive power source is through an active or passive RFID tag. With this method, an RFID tag may be printed onto the same circuit board as the inductive power source or the LED light. It may also be printed onto a separate chip or an adhesive label that is applied onto the device or the external packaging.

A further method for communication with the inductive power source involves a recharging an inductive coil that receives energy in the form of an electromagnetic field from an inductive charging pad or other device. The energy is converted into AC or DC current that is used either to recharge an onboard rechargeable battery or to provide current directly to the LED light.

When using an inductive power source, materials selection of the device, base materials and vessel must be done carefully in order not to have potentially undesirable effects on the foreign object detection analysis method that the inductive charging system might have. Magnetic or metallic objects may provide unwanted effects on the electromagnetic field that is powering the device. Therefore, unlike in the teaching of the prior art for packaging of LED lights in glass vessels, in this embodiment, a metallic base component attached to the glass vessel may undesirable. Instead, a plastic or other non-conductive material may be desirable.

The inductive field may disrupt or heat up the portion of the printed circuit board that is above the inductive transmitting device. Therefore, a magnetic shield may be placed between the printed circuit board and the receiving coil. It may be desirable to either include the receiving coil on the opposite side of the printed circuit board, to connect it through the printed circuit board, or to attach it with flexible leads to the top of the printed circuit board such that it may be wrapped around to the opposite side of the microcontroller and the LED lights.

The electromagnetic conversion efficiency is reduce if the receiver coil and the transmitter coils are not properly aligned. For this reason, it may be desirable to include a device for helping to align the electromagnetic fields. One design option for achieving this goal may be to include magnets inside of the receiving coil or the transmitter coil, the magnets being of opposite polarization such that they ‘pull’ the devices together when they are in within the magnetic fields.

It may be desirable to include a method for the transmitter coil to detect whether or not there is an appropriate receiver coil in range of the inductive field. Because the transmitter coil energy could potentially heat foreign metal object in the field, it would be safer if the coil was only powered on if a receiver coil was detected in close proximity. There are several methods for achieving communication. One such method may be to employ an RFID device as part of the receiving device. Another method may be the inclusion of a small transmitter in the receiving device. The transmitter device may send ‘pings’ periodically to sense whether or not the receiving device is in proximity. A foreign object detection system may also be included in the inductive power source device, included a Parasitic Loss Detection (PLO) system design, wherein the transmitter device can detect the parasitic loss of the system. In one version of this, the transmitter device could perform onboard calculations to determine whether or not there is parasitic power, potentially by measuring the difference between a signal from the receiving device containing information about the power that is received by the receiving coil and a predictive algorithm that is programmed into the power transmitting device. The power transmitter coil device may also have learning built into the design of the algorithm, such as by using a Kalman filter algorithm. A thermocouple or other temperature sensor may be included in either the receiver or the transmitter device.

There are several possible coil designs that would work in this device. There are differences in material thicknesses, diameters, coil lengths, and coil spacings that could make sense. In general, a copper coil with less than 25 revolutions is preferred, with spacing between the coils no more than five times that of the diameter of the coil. A single coil or two-coil design may be employed. The coil may also be designed to employ resonant coupling of the electromagnetic field. Resonant coupling increases the distance that energy may be transferred between the transmitting and receiving coils. In general, this distance would be less than 5 cm distance, and more likely to be 1-2 cm. With magnetic coupling this distance may be increased. However, resonant coupling also requires a more precise alignment of electromagnetic fields or the energy conversion efficiency can be negatively affected.

The presence of an inductive power source may provide a more constant source of power, without the limitations of limited battery life. Constant changing of batteries, recharging of batteries, or plugging a bottle into a wall is generally either inconvenient, undesirable, or not aesthetically pleasing. In contrast, an inductive power source can be designed that is aesthetically pleasing. This enables selection of a brighter LED light and activation methods which are more frequent. Therefore, a tilt sensor and timer may not be desired with a version of the bottle-light design that includes an inductive power source. For example, an 80 mA LED may be used that provides exceptional brightness similar to that of a commercial headlamp or flashlight, providing exceptional visibility to the user or to potential customers. This may be useful as a marketing tool in a bar, club or retail setting.

Power source for transmitter coil. The transmitter coil is likely to be connected to a wall-type electrical outlet, such as an 110V two-pronged outlet through a series of energy conversion components. The transmitter coil unit itself may be connected to an additional voltage conversion device. For example, a USB cable, mobile phone, smart phone or camera charging device may connect the transmitter coil power unit to the wall outlet. The transmitter coil may also be connected to a battery, a solar panel. The transmitter coil device may also be powered wirelessly itself from another transmitter coil. The transmitter coil device may also be wired directly into the building's electrical system.

In one embodiment, a tilt-activated LED light device comprises a battery, an LED light, a tilt switch, a microcontroller, an on-off switch, resistors, capacitors, a PCB board, and other power electronics. The microcontroller is programmed to turn on the light periodically or when the device is inverted. The device is designed to fit in a 3″ diameter area such that it may be contained inside a beverage bottle such that the bottle is light from the interior when the bottle is inverted, or when the bottle sits on the shelf and the light is activated by the microcontroller timer.

The bottle comprises a container portion; one or more LED light sources for illuminating selected portions of the container portion; and one or more switches connected to the light sources for selectively illuminating the light sources as desired.

In another embodiment, the disclosure is a distilled alcohol that has a light on the bottom of the bottle, preferably in the 750 mL size. The light is an LED & is powered by a primary or rechargeable battery that is encased in the base. A type of on/off switch is included that determines whether or not the bottle is operating at all. Multiple operating modes may be included.

In a further embodiment, a motion-activated LED light device comprises a battery, an LED light, a tilt sensor, a microcontroller, an on-off switch, resistors, capacitors, an etched substrate, and other power management electronics. The microcontroller is programmed to turn on the light periodically or when the device is inverted. The device is designed to fit in a 3″ diameter area such that it may be contained inside a beverage bottle such that the bottle is light from the interior when the bottle is inverted, or when the bottle sits on the shelf and the light is activated by the microcontroller timer.

### SUMMARY

In one embodiment, a light-emitting container includes a hollow vessel and a light-emitting device. The hollow vessel has an open end and a closed end. At least a portion of the hollow vessel is one of transparent and translucent. The light-emitting device is disposed adjacent the closed end of the vessel. The light-emitting device includes a microcontroller in electrical communication with at least one light source. The microcontroller selectively causes one of an activation and a deactivation of the at least one light source. A light is emitted from the at least one light source and transmitted through the vessel upon the activation of the at least one light source.

In another embodiment, a light-emitting container, the light-emitting device includes a printed circuit board. The printed circuit board has at least one power source, a microcontroller, a tilt switch, and at least one light source. The power source includes at least one of a battery, a capacitor, and an inductive pickup coil. The microcontroller is in electrical communication with the at least one power source. The tilt switch is in electrical communication with the microcontroller. The at least one light source in electrical communication with the microcontroller and the at least one power source. The microcontroller selectively causes one of an activation and a deactivation of the at least one light source following a tilting of the vessel.

In a further embodiment, a light-emitting container system includes the light-emitting container and a charging station. The light-emitting device of the light-emitting container includes an inductive pickup coil as the power source. The charging station includes an inductive charging coil for wirelessly generating an electric current in the inductive pickup coil, thereby wirelessly powering the light-emitting container.

### DRAWINGS

The above, as well as other advantages of the present disclosure, will become readily apparent to those skilled in the art from the following detailed description, particularly when considered in the light of the drawings described hereafter.

FIG. 1 is a perspective view of a light-emitting container according to one embodiment of the present disclosure;

FIG. 2 is an exploded perspective view of the light-emitting container illustrated in FIG. 1;

FIG. 3 is a top plan view of a light emitting device for use with the light-emitting container illustrated in FIG. 1;

FIG. 4 is a circuit diagram schematic for a light emitting device according to a particular embodiment of the present disclosure;

FIGS. 5-6 show an operation of the light-emitting container illustrated in FIG. 1, the light-emitting container operated by a tilting of the light-emitting container;

FIG. 7 is an exploded perspective view of the light-emitting container according to another embodiment of the disclosure, showing a threaded base for affixing to a threaded end of the light-emitting container;

FIG. 8 is an exploded perspective view of the light-emitting container according to a further embodiment of the disclosure, showing a faceted upper surface for refraction of light emitted by the light-emitting container;

FIG. 9 is an exploded perspective view of the light-emitting container according to an additional embodiment of the disclosure, showing a faceted punt for refraction of light emitted by the light-emitting container;

FIG. 10 is a perspective view of a light-emitting container system according to the present disclosure, including a light-emitting container and an inductive charging station;

FIG. 11 is a schematic diagram of a light-emitting container system according to one embodiment of the present disclosure;

FIG. 12 is a circuit diagram schematic of a power pickup unit for a light-emitting container according to a particular embodiment of present disclosure;

FIG. 13 is a circuit diagram schematic of the power pickup unit illustrated in FIG. 12 cooperating with a transmitter of an inductive charging station to power a light-emitting container having the power pickup unit; and

FIG. 14 is a circuit diagram schematic of the light-emitting container system according to another embodiment of the present disclosure.

### DETAILED DESCRIPTION OF THE INVENTION

The following detailed description and appended drawings describe and illustrate various exemplary embodiments of the invention. The description and drawings serve to enable one skilled in the art to make and use the invention, and are not intended to limit the present disclosure, application, or uses. In respect of the methods disclosed, the order of the steps presented is exemplary in nature, and thus, is not necessary or critical.

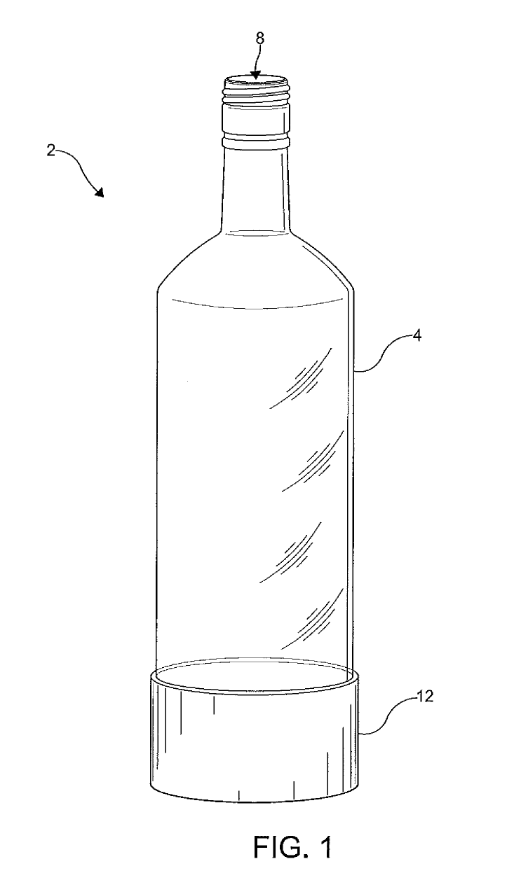

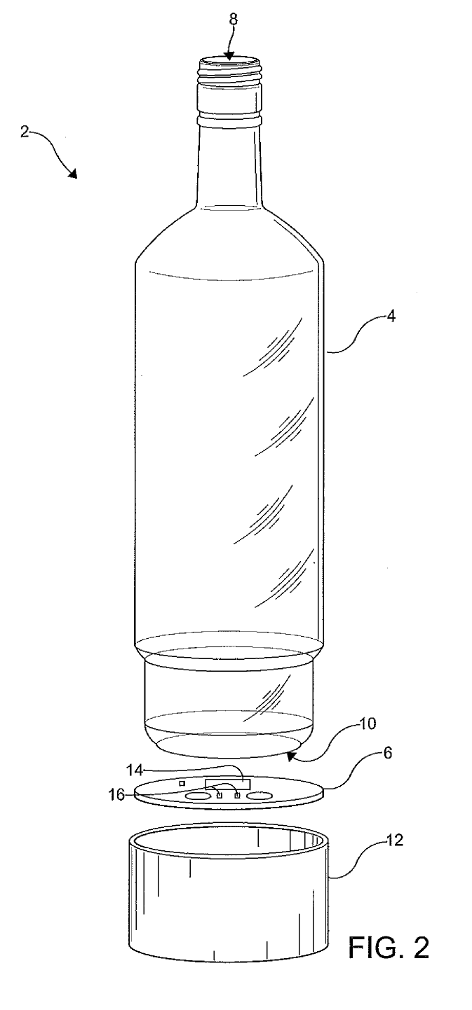

FIGS. 1-2 show a light-emitting container 2 according to one embodiment of the present disclosure. The light-emitting container 2 includes a hollow vessel 4 and a light-emitting device 6. The light-emitting container 2 has an open end 8 and a closed end 10. The light-emitting container 2 is one of transparent and translucent, and thereby permits light to be transmitted therethrough. As a nonlimiting example, the light-emitting container 2 may be a glass or plastic bottle configured to hold a liquid such as a beverage. Other types of containers 2 may also be used within the scope of the disclosure.

The light-emitting container 2 may further include a hollow base 12. The base 12 cooperates with the closed end 10 of the vessel 4. The base 12 may be transparent, translucent, or opaque, as desired. The light-emitting device 6 is disposed inside of the base 12 and adjacent the closed end 10 of the vessel. The light-emitting device 6 is configured to selectively light the light-emitting container 2 through the closed end 10 of the vessel 4 when activated.

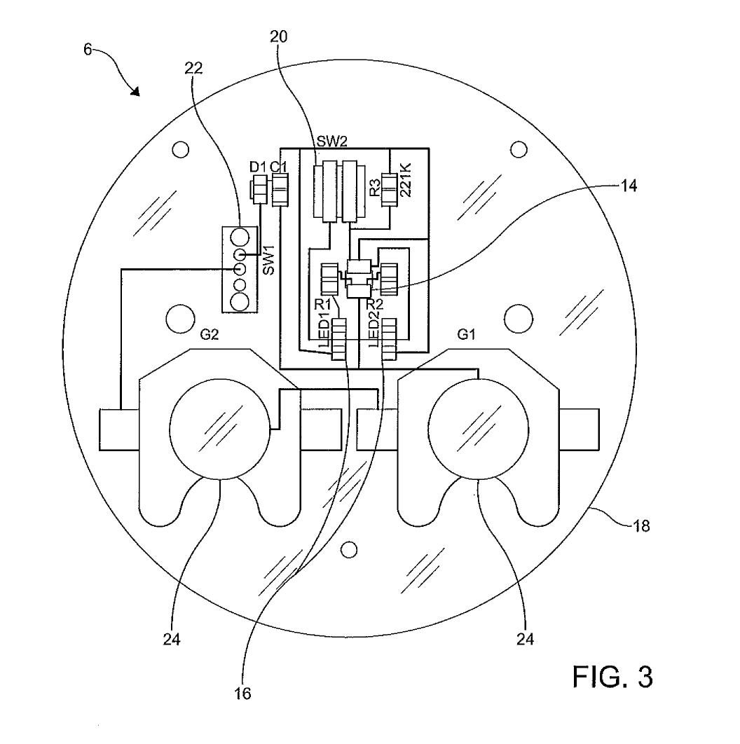

Referring to FIG. 3, the light-emitting device 6 includes a microcontroller 14 in electrical communication with at least one light source 16. As a nonlimiting example, the microcontroller 14 may be a flash-based CMOS microcontroller. As a further nonlimiting example, the microcontroller 14 may measure about 5 mm by 5 mm, have a test current between 10 and 100 milliamperes, and have an operating voltage range between 2V and 8V. However, microcontrollers 14 of others types, sizes, test currents, and voltage ranges may also be used within the scope of the disclosure.

The microcontroller 14 is programmed to selectively cause one of an activation and a deactivation of the at least one light source 16. In particular embodiments, the microcontroller 14 is a low-power programmable microcontroller, programmed to alter electric current to the at least one light source 16. The microcontroller 14 desirably controls the at least one light source 16 and other components of the light-emitting device 6. More than one microcontroller 14 working together, or individually, may be used. Other suitable types of microcontrollers 14 may also be employed, as desired.

The at least one light source 16 according to the present disclosure may include any type of light source 16 that may be readily controlled by the microcontroller 14. For example, the at least one light source 16 may include a light emitting diode (LED). The use of LED is particularly advantageous, as LED can be provided in a strip or surface mountable reel format that is particularly conducive to a low-cost robotic manufacturing of the light-emitting device 6 for the light-emitting container 2 of the disclosure.

In certain embodiments, the LED size is less than 5 mm by 5 mm. The luminous intensity of the LED may be between 50 and 5000. As a nonlimiting example, the LED may be a white indium gallium arsenide surface mountable LED with luminous intensity greater than 500 millicandela with a current requirement being less than 100 milliamperes. Other sizes and luminous intensities for the LED may be selected by a skilled artisan, as desired.

In illustrative embodiments, the at least one light source 16 includes at least two LED. The two LED may have the same or a different wavelength or color of light, as desired. For example, one of the LED may emit a wavelength of light providing an amber color, and the other LED may emit a wavelength of light providing a blue color. The two LED may be activated and deactivated simultaneously, or independently, by the microcontroller 14. One of ordinary skill in the art may select other wavelengths of light, as well as types and numbers of the at least one light source 16, as desired.

It should be appreciated that the light emitted from the at least one light source 16 is transmitted through the vessel 4 upon the activation of the at least one light source 16. An aesthetically pleasing appearance is thereby provided to the light-emitting bottle 2, which may be particularly advantageous for reasons or marketing and enjoyment of the end-user.

In certain embodiments, the light-emitting device 6 includes a printed circuit board (PCB) 18. The microcontroller 14 and the at least one light source 16 are disposed on the PCB 18. It should be appreciated that the use of the PCB 18 is particularly advantageous as it permits an inexpensive manufacturing of the light-emitting device 6, for example, by robotics and the like. As particular examples, the PCB 18 may be single-sided, and fit within a footprint that is does not exceed in any dimension a circle with a 4-inch diameter. Other sizes and shapes for the PCB 18 may also be used.

The PCB 18 may also include sensors in electrical communication with the microcontroller 14. The sensors may include any type of sensor for detecting movement of the light-emitting bottle, for example, a motion sensor, a touch (capacitance) sensor, and a vibration sensor. In one example, the sensor of the PCB 18 includes a tilt switch 20. The tilt switch 20 is in electrical communication with the microcontroller 14 and the at least one light source 16. A tilting of the vessel 4 may cause the activation of the at least one light source 16, as desired. The microcontroller 14 may be programmed to deactivate the at least one light source 16 after a predetermined period of time following the tilting of the vessel 4. In other embodiments, the tilt switch 20 may result in the deactivation of the at least one light source 16 when the light-emitting container 2 is moved from the tilted position to an upright position. Other means for deactivating the at least one light source 16 after a period of activation upon tilting of the light-emitting container 2 may also be used within the scope of the disclosure.

As a nonlimiting example, the tilt switch 20 may be provided as a rolling-ball switch that is one of activated and deactivated when gravity causes a conductive bearing to one of complete and break an electric circuit. In another example, the tilt switch 20 may be an accelerometer configured to one of complete and break the electric circuit upon a tilting of the vessel 4. In a further example, the tilt switch is a fluid-containing switch that is one of activated and deactivated when gravity causes a contained fluid to one of complete and break the electric circuit. Suitable types of tilt switches are also described in U.S. Pat. Nos. 7,446,272 and 6,518,523 to Chou, the entire disclosures of which are hereby incorporated herein by reference. Skilled artisans should appreciate that other suitable types of tilt switches 20 may also be used within the scope of the disclosure.

The PCB 18 of the light-emitting device 6 may further include a manual on/off switch 22. The on/off switch 22 permits a user to selectively power the light-emitting device 6 for operation. For example, the on/off switch 22 may be a slide switch that may be slid by the user between an on position and an off position. In other examples, the on/off switch is a push button. In particular embodiment, the on/off switch 22 is accessible to the user through a slot formed in the base 12. Other means for powering the light-emitting container 2 on and off may also be used, as desired.

The microcontroller 14 of the light-emitting device 4 may further include a timer. The timer may be a digital or analog clock, for example, in the form of a program residing on the microcontroller 14. The timer may be an 8-bit timer, for example. Based on the timer, the microcontroller 14 may periodically cause the activation of the at least one light source 16. For example, the microcontroller 14 may be programmed to periodically cause the activation of the at least one light source 16 for a length of time between 0 and 60 minutes per day, and more particularly between 10 seconds and 2 minutes per hour. In another example, the microcontroller 14 may be programmed to activate the at least one light source 16 only during specified hours of the day. In a further example, the microcontroller 14 is programmed to light the LED on timer between 0.1% and 5% of the time. It should be understood that other suitable lengths and periods of time for timed activation by the microcontroller 14 may also be used.

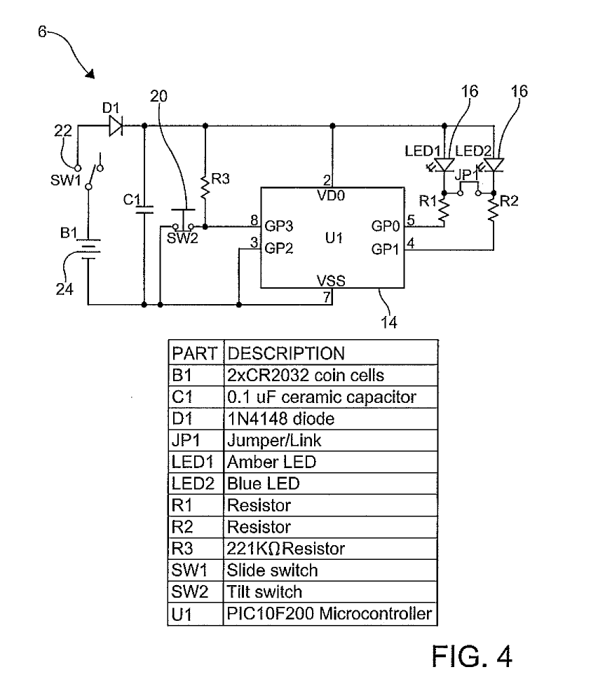

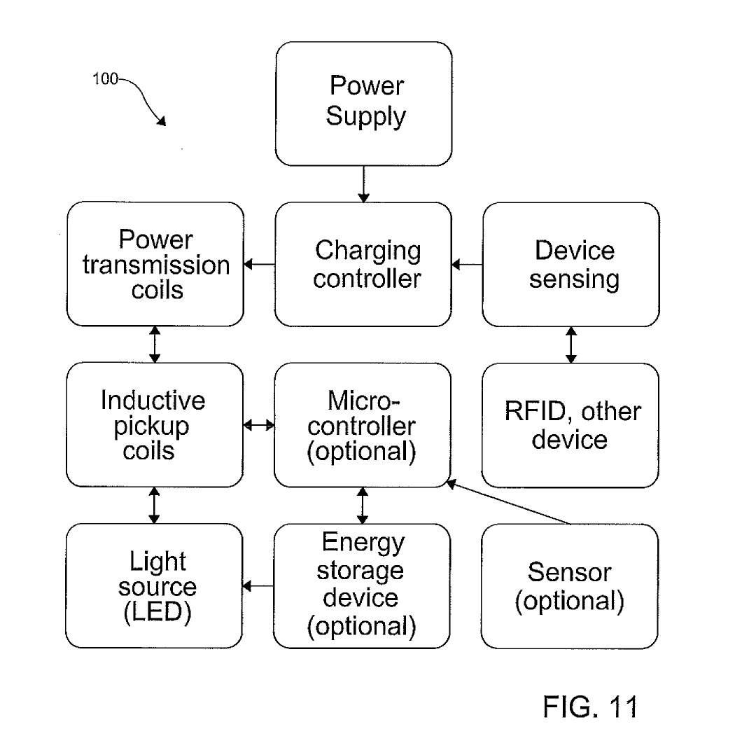

The light-emitting device 6 also includes a power source 24. The power source 24 is in electrical communication with the microcontroller 14 and the at least one light source 16. The power source 24 may includes at least one of a battery (shown in FIGS. 3 and 4), a capacitor (shown in FIGS. 3 and 4), and an inductive pickup coil (shown in FIGS. 11 to 13) for supplying electrical power to the microcontroller 14 and the at least one light source 16. The battery, the capacitor, and the inductive pickup coil may be used together in any combination, or individually, to power the light-emitting device 6. Where the power source 24 includes the battery, it should be understood that more than one battery may be connected, in series or in parallel, to provide a suitable amount of electrical power for the at least one light source 16 being employed. In an illustrative embodiment, the total energy contained in the power source 24 may not exceed 3 amp-hours. Where the PCB 18 is used, a pair of coin cell batteries connected in series has been shown to supply a suitable electrical power. Other types of power sources 24 are also contemplated and may be used within the scope of the disclosure.

The PCB 18 may further include a voltage step-up embedded onto the PCB 18, in order to boost the operating voltage of the circuit above the voltage that is otherwise provided by the at least one power source 24.

As shown in FIGS. 3 to 4, the light-emitting device 6 may also include other components permitting the microcontroller 14 to selectively operate the at least one light source 16. These other components may include resistors, capacitor, diodes, etc. The electrical circuitry identified in FIG. 4 is exemplary in nature, and one of ordinary skill in the art may select other suitable electrical circuitry permitting the microcontroller 14 to control, that is, activate and deactivate, the at least one light source 16, as desired.

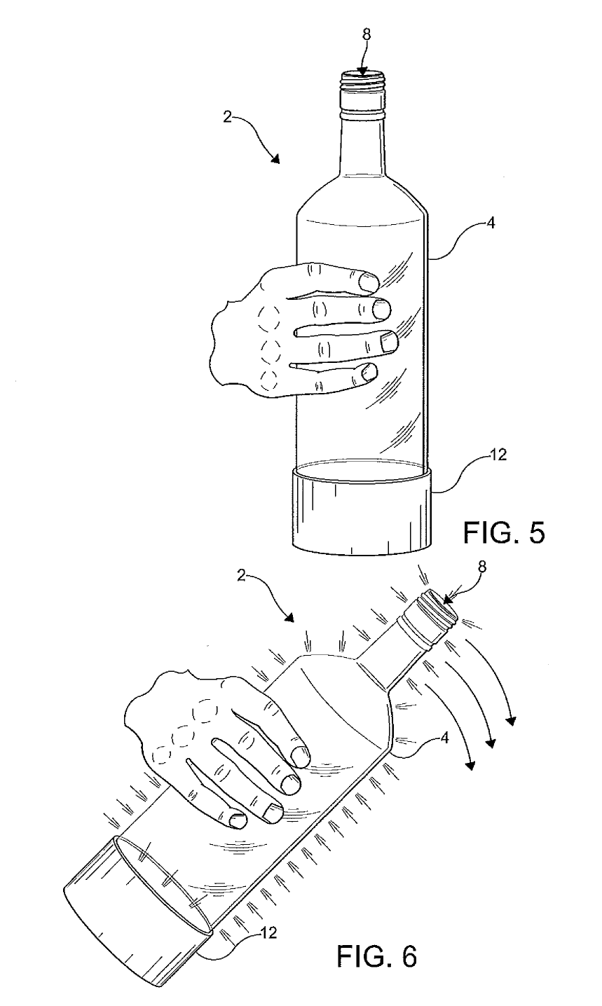

Referring now to FIGS. 5 and 6, an operation of the light-emitting container 2 according to one embodiment of the disclosure is shown. FIG. 5 depicts the light-emitting container 2 in an upright position and unlit, in which the at least one light source 16 has not been activated. As the user begins to tilt the light-emitting container 2, shown in FIG. 6, from the upright position, the at least one light source 16 is activated. The light-emitting container 2 is thereby lit, as the light from the least one light source 16 is transmitted through the walls of the light-emitting container 2. Where the light-emitting container 2 is subsequently returned to the upright position, the at least one light source may be deactivated after a predetermined period of time by the microcontroller 14, or may be immediately deactivated, as desired.

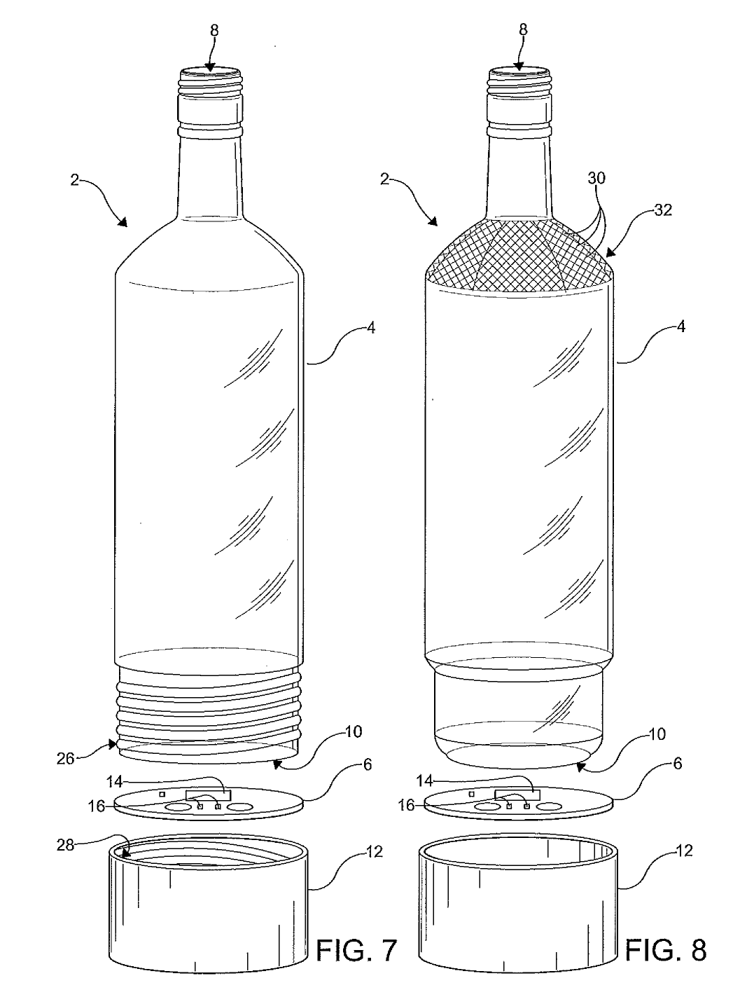

The base 12 that contains the light-emitting device 6 may be permanently or removably affixed to the closed end 10 of the vessel 4, as desired. In one embodiment, shown in FIG. 7, the base 12 is removably affixed by threadable engagement with the closed end 10 of the vessel 4. In particular, the closed end 10 of the vessel 4 has external threads 26 and the base 12 has internal threads 28. The external threads 26 of the vessel 4 cooperate with the internal threads 28 of the base 12 to removably affix the base 12 to the closed end 10 of the vessel 4.

In another embodiment, shown in FIG. 8, the base 12 may be affixed to the closed end 10 of the vessel 4 with a friction fit. For example, the closed end 10 may have an average diameter less than the maximum diameter of the vessel 4, and sized appropriately to fit snugly within the base 12. An adhesive may further be employed to permanently secure the closed end 10 of the vessel 4 within the base 12. The use of mechanical fasteners such as rivets, clips, etc. to fasten the closed end 10 of the vessel 4 with the base 12 is also contemplated, and within the scope of the disclosure

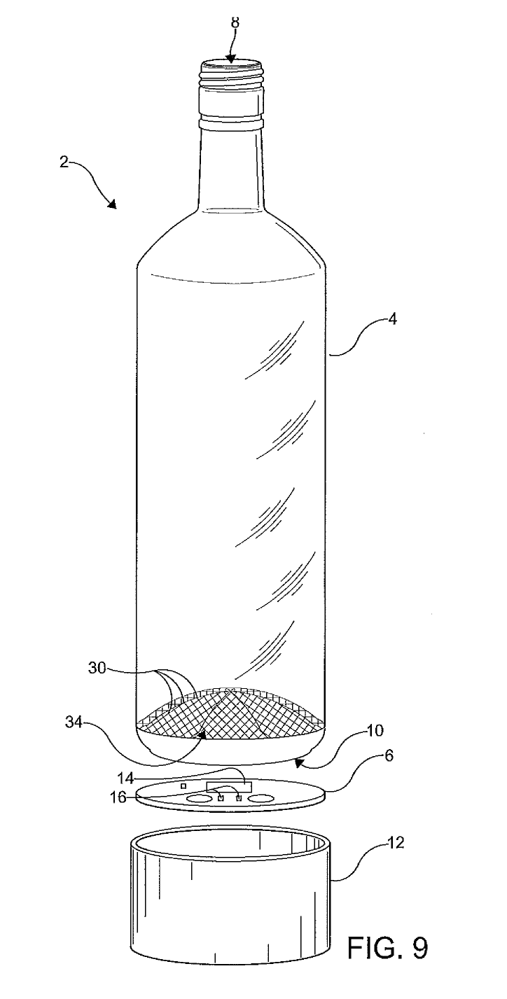

In addition to being at least one of transparent and translucent, to permit the transmission of the light emitted by the light-emitting device 2 through the walls of the vessel 4, at least a portion of the hollow vessel 4 may have facets 30. The facets 30 may be on an inner surface or an outer surface, or both the inner surface and the outer surface, of the vessel 4, as desired. The facets 30 on the vessel 4 may facilitate a scattering of the light emitted from the at least one light source 6, and contribute to the aesthetically pleasing appearance of the light-emitting container when in operation. In one example, shown in FIG. 8, an upper portion 32 of the light-emitting container 2 adjacent the open end 8 may have the facets 30. In another example, shown in FIG. 9, the closed end 10 of the hollow vessel 4 may have a punt 34 with the facets 30. It should be appreciated that the punt 34 may also provide additional space for the light-emitting device 6 contained within the base 12 adjacent the closed end 10 of the vessel 4. Other locations for the facets 30 may also be used.

As an alternative to facets 30, it should be appreciated that other types of surface texturing of the container 2, such as frosting and the like, may also be used to create further refraction of the light generated by the light-emitting device 2.

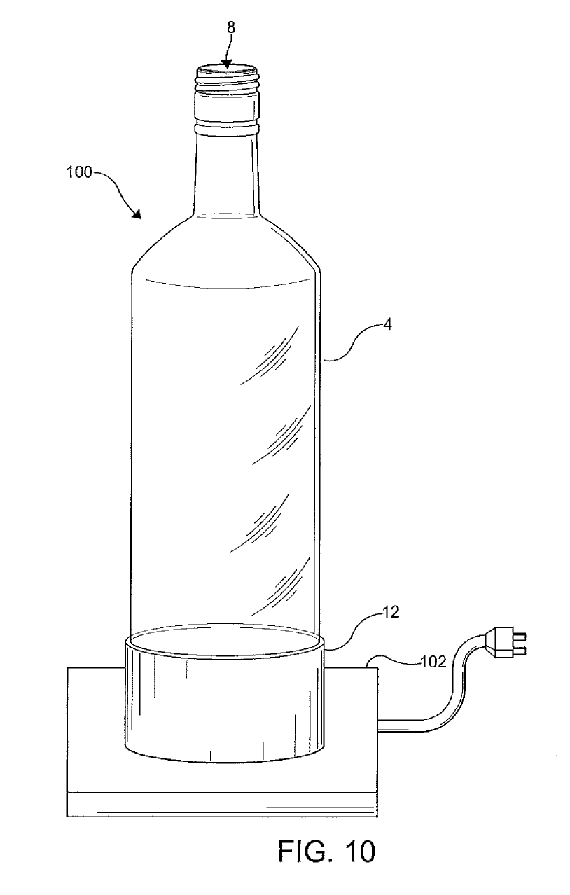

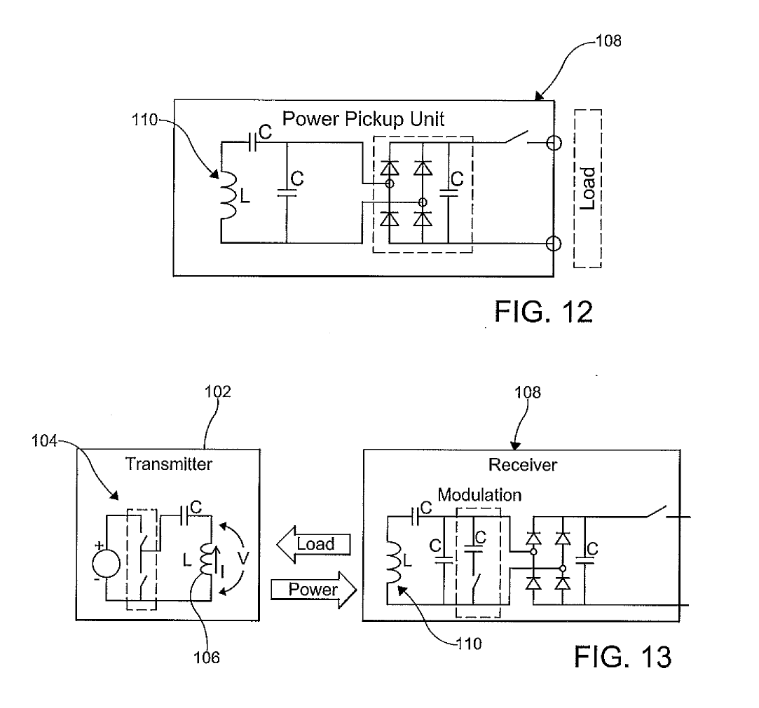

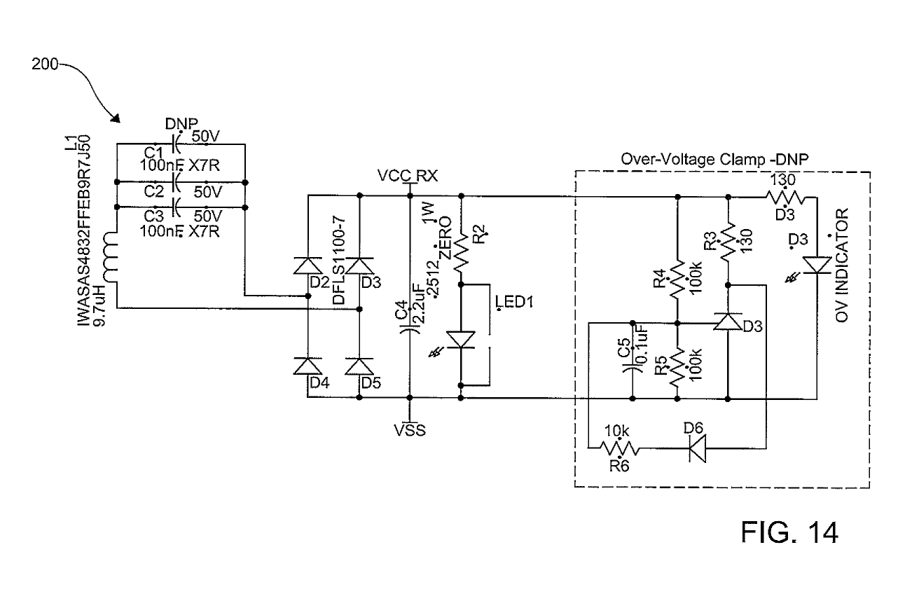

Referring now to FIGS. 10 to 13, a light-emitting container system 100 according to one embodiment of the disclosure is illustrated. The light-emitting container system 100 includes the light-emitting container 2 and a charging station 102. The charging station 102 may include a pad or a receptacle for the receiving the base 12 of the light-emitting container 2, and wirelessly powering the light-emitting container 2. For example, the charging station 102 may include a transmitter 104 (shown in FIG. 13) having an inductive charging coil 106 for wirelessly generating an electric current in a power pickup unit 108 (shown in FIG. 12) of the light-emitting container 2. The charging station 102 may also sense or detect the light-emitting container 2, so as to selectively induce the electric current in the power pickup unit 108 when the light-emitting container 2 is placed near the charging station 102. An exemplary light-emitting container system 200 according to another embodiment of the disclosure is also shown in FIG. 14.

The power pickup unit 108 may serve as the at least one power source 24 for the light-emitting container 2. The power pickup unit 108 may be formed on the PCB 18, for example. The power pickup unit 108 includes a receiver 110 with an inductive pickup coil in which the electric current is induced by the inductive charging coil 106 of the charging station 102. Capacitors or electrochemical batteries may be used to store the power provided by the charging station 102, for later use by the light-emitting device 6 in lighting the light-emitting container 2 of the disclosure.

Advantageously, the light-emitting container 2 of the present disclosure is both visually appealing and affordable. The container 2 when handled by the end-user provides a unique and pleasurable experience, not provided by known containers in the art.

While certain representative embodiments and details have been shown for purposes of illustrating the invention, it will be apparent to those skilled in the art that various changes may be made without departing from the scope of the disclosure, which is further described in the following appended claims.

What is claimed is:

1. A light-emitting container, comprising:
a hollow vessel having an open end and a closed end, at least a portion of the vessel being one of transparent and translucent; and
a light-emitting device disposed adjacent the closed end of the vessel, the light-emitting device including a microcontroller in electrical communication with at least one light source, the microcontroller selectively causing one of an activation and a deactivation of the at least one light source, a light emitted from the at least one light source and transmitted through the vessel upon the activation of the at least one light source.

2. The light-emitting container of claim 1, further including a hollow base cooperating with the closed end of the vessel, the light-emitting device disposed inside of the base.

3. The light-emitting container of claim 2, wherein the closed end of the vessel has external threads and the base has internal threads, the external threads of the vessel cooperating with the internal threads of the base to affix the base to the closed end of the vessel.

4. The light-emitting container of claim 2, wherein the base is affixed to the closed end of the vessel with one of a friction fit, a latch and an adhesive.

5. The light-emitting container of claim 1, wherein the closed end of the hollow vessel has a punt that provides additional space for the light-emitting device.

6. The light-emitting container of claim 1, wherein at least a portion of the hollow vessel is faceted to facilitate a scattering of the light emitted from the at least one light source.

7. The light-emitting container of claim 1, wherein the light-emitting device includes a printed circuit board, the microcontroller and the at least one light source disposed on the printed circuit board.

8. The light-emitting container of claim 1, wherein the light-emitting device further includes a tilt switch in electrical communication with the microcontroller, a tilting of the vessel causing the activation of the at least one light source, wherein the tilt switch is one of
a rolling-ball switch that is one of activated and deactivated when gravity causes a conductive bearing to one of complete and break an electric circuit;
an accelerometer configured to one of complete and break the electric circuit upon a tilting of the vessel; and
a fluid-containing switch that is one of activated and deactivated when gravity causes a contained fluid to one of complete and break the electric circuit.

9. The light-emitting container of claim 8, wherein the microcontroller is programmed to deactivate the at least one light source after a predetermined period of time following the tilting of the vessel.

10. The light-emitting container of claim 1, wherein the microcontroller includes a timer that periodically causes the activation of the at least one light source by the microcontroller.

11. The light-emitting container of claim 1, wherein the light-emitting device further includes a manual on/off switch that permits a user to selectively power the light-emitting device for operation.

12. The light-emitting container of claim 1, wherein the light-emitting device further has a power source in electrical communication with the microcontroller and the at least one light source, the power source including at least one of a battery, a capacitor, and an inductive pickup coil for supplying electrical power to the microcontroller and the at least one light source.

13. The light-emitting container of claim 12, wherein the power source includes one of multiple batteries in series and a single battery with a boost converter in order to elevate a voltage above a level of a single battery.

14. The light-emitting container of claim 1, wherein the at least one light source includes at least two light emitting diodes (LEDs).

15. The light-emitting container of claim 1, wherein the microcontroller is a low-power programmable microcontroller with less than 100 nA of current drawn while in sleep mode, programmed to alter electric current to the at least one light source.

16. The light-emitting container of claim 1, wherein the vessel includes frosted glass.

17. The light-emitting container of claim 1, manufactured according to a method comprising the steps of:
sending electronic file instructions to a printed circuit board manufacturing and surface mount assembly line;
robotically assembling a printed circuit board having the microcontroller and the at least one light source using the instructions;
securing the assembled printed circuit board to an external base piece using a fastener;
securing the external base piece to the vessel; and
filling the vessel with a liquid.

18. A light-emitting container, comprising:
a hollow vessel having an open end and a closed end, at least a portion of the vessel being one of transparent and translucent;
a hollow base cooperating with the closed end of the vessel; and
a light-emitting device disposed adjacent the closed end of the vessel and inside of the base, the light-emitting device including a printed circuit board having
at least one power source including at least one of a battery, a capacitor, and an inductive pickup coil,
a microcontroller in electrical communication with the at least one power source,
a tilt switch in electrical communication with the microcontroller, and
at least one light source in electrical communication with the microcontroller and the at least one power source,
wherein the microcontroller selectively causes one of an activation and a deactivation of the at least one light source following a tilting of the vessel, a light emitted from the at least one light source and transmitted through the vessel upon the activation of the at least one light source.

19. A light-emitting container system, comprising:
a light-emitting container including
a hollow vessel having an open end and a closed end, at least a portion of the vessel being one of transparent and translucent,
a hollow base cooperating with the closed end of the vessel, and
a light-emitting device disposed adjacent the closed end of the vessel and inside of the base, the light-emitting device including a printed circuit board having
at least one power source including an inductive pickup coil,
a microcontroller in electrical communication with the at least one power source,
at least one light source in electrical communication with the microcontroller and the at least one power source,
a charging station including an inductive charging coil for wirelessly generating an electric current in the inductive pickup coil of the at least one power source.

20. The light-emitting container system of claim 19, wherein the charging station recognizes the light-emitting container with the inductive pickup coil, and wherein the charging station only induces a current in the inductive pickup coil when the charging station senses the light-emitting container.
